(19) United States
(12) Patent Application Publication
(10) Pub. No.: US 2015/0235183 A1
(43) Pub. Date: Aug. 20, 2015

(54) COMPUTER-IMPLEMENTED METHOD AND SYSTEM FOR SCHEDULING APPOINTMENTS WITH CLIENTS

(71) Applicants: Evan SAMPSON, Edmonton (CA); Hernish ACHARYA, Edmonton (CA)

(72) Inventors: Evan SAMPSON, Edmonton (CA); Hernish ACHARYA, Edmonton (CA)

(21) Appl. No.: 14/185,578

(22) Filed: Feb. 20, 2014

(51) Int. Cl. G06Q 10/10

(52) U.S. Cl. CPC G06Q 10/1095

(57) ABSTRACT

The invention described herein is a computer implemented method and system for scheduling an appointment between a provider and one of a plurality of waiting clients that are matched and ranked by likelihood of availability. The moment the provider inputs an available appointment opening into the system, the system cross-references the appointment time with the clients' availability and multiple other temporal, geographical, and situational variables; selects and ranks the clients who are likely able to attend the appointment opening; and sends said clients a computer-generated notification message (via email and/or SMS text message and/or voice message) regarding the appointment opening. The clients' availability and their temporal, geographic, and situational variables may be updated by the system in real-time so that the system selects and ranks clients based on availability information that is as accurate as possible.

### FIELD OF THE INVENTION

The present invention relates to a computer implemented method and system of scheduling of appointments, and in particular, such a method and system that selectively provides notification of open appointments to clients on a wait list based on the likelihood of their availability for the appointment, as may be updated in real time.

### BACKGROUND OF THE INVENTION

Appointment-based service-providing businesses are faced with the daily problem of having to deal with unexpected openings in their appointment or reservation calendar due to late or last-minute cancellations. For example, research has reported that almost 20% of appointments with specialist physicians are cancelled and require re-booking (Parikh et al., 2010). Further evidence reveals up to a 30% rate of no-shows for medical appointments (Lehmann et al., 2007). Reminder phone calls prior to the appointment date and time have been shown to decrease the no-show rate, but significantly increase the cancellation rate (Parikh et al., 2010), which still leaves the problem of an unfilled appointment opening. The process of identifying and contacting potential alternate clients or customers to fill the resulting vacancies is a time-consuming drain on resources and is frequently unsuccessful. It generally involves maintenance of a contact list (waitlist) and making multiple phone calls to members of the list to enquire as to their availability for the particular schedule opening prior to the expiry of the available opening, which is often imminent. This is costly to the business in terms of lost productivity, as well as missed appointment income should the opening fail to be filled. Unfilled openings also represent a lost opportunity to other individuals on the waitlist who may have actually been available to attend the open appointment.

U.S. Pat. No. 7,865,386 to Sarkar discloses an online appointment scheduling method and system which sends real-time alert messages to notify users of a newly available appointment schedule when there is a cancellation of an appointment. Such a system, however, does not allow for consideration of situational factors that may affect the availability of the user, does not prioritize multiple users, or manage the solicitation of multiple users. These features are particularly important where there is an excess demand for appointments, and situational factors need to be considered in best practices for scheduling appointments, whether this is for commercial or non-commercial reasons.

Accordingly, there is a need in the art for a method and system for scheduling appointments, and in particular a method and system responsive to untimely appointment openings to fill the openings with greater efficiency, effectiveness, and discrimination among clients than methods and systems in the prior art. Preferably, such a system and method allows individuals to self-subscribe to a waitlist, minimizes the element of chance in determining which individuals on the waitlist are most likely to be able to attend any given appointment opening, and automatically generates and delivers messages to said individuals, in order to reduce administrative costs, reduce lost productivity, reduce lost provider revenue, and shorten waitlists.

### SUMMARY OF THE INVENTION

Disclosed herein is a computer-based method and system for performing a task that is ubiquitous in appointment-based service-providing businesses, many of which have full appointment schedules and maintain a wait list of clients who would be willing to come in and attend an unexpected schedule opening with the provider, should they be made aware of the available opening: that of identifying which of the clients are suitable to fill the opening, and if more than one client is suitable, prioritizing amongst the suitable clients, and contacting the suitable client(s) to fill the opening upon the arising of a cancellation.

The method and system disclosed herein is implemented by a computer having a processor and an operatively connected memory storing a set of instructions to which the processor is responsive. In one embodiment, the computer may comprise a system device which is in communication via a network (e.g., the Internet, an intranet, a wide area network, a local area network, a public switched telephone network, or a combination thereof) with a provider device and a plurality of client devices (computers) each used by at least one of the clients on the wait list. A client may use one of a plurality of client devices available to that client. Alternatively, the system device may be the same as the provider device, which is in network communication with the plurality of client devices.

The method and system disclosed herein is responsive to an appointment availability notification (e.g., arising from a provider making new appointments available, or due to the cancellation of an appointment by a provider or a client) to match, and in one embodiment also rank, clients on a wait list based on client profile values. In embodiments, the client profile values may include temporal factors (e.g., client availability period; a cumulative time of client availability periods; client waiting time; client advance notice period; appointment duration), geographic factors (e.g. client location), and situational factors (e.g. client urgency). In one embodiment, clients may self-subscribe to the wait list to define their specific temporal availability and provide location information to the system. In one embodiment, the client may provide updated location information from time-to-time, including real-time client location updates provided by, and in embodiments generated by, the client device, so that the system matches and ranks clients on the most accurate information available at any given time.

In one embodiment, providers may also define specific client profile values for the clients subscribed to their waitlist including appointment type (e.g., the purpose of a medical visit), urgency, duration of appointment required, and demographic factors related to the client (e.g., a patient's age or medical condition) as well as appointment profile values such as appointment time, appointment location, appointment duration, or appointment type. Based on analysis of these multiple variables, the system employs a dynamic matching algorithm, and in one embodiment a ranking algorithm, which selects at least one client from the wait list who is or are most likely to be able to fill the appointment opening. In one embodiment, a plurality of clients are selected, and the system automatically generates and sends appointment opening notification messages to said selected clients via a suitable message service, such as SMS (short message service) message, e-mail, or telephone call.

In one embodiment, the matching and ranking algorithm dynamically weighs all factors depending on the parameters of the available appointment. In one embodiment, an initial matched list is generated based on absolute stated temporal availability of the client. For example, if the appointment opening is on a Wednesday afternoon, only clients who have declared themselves available on Wednesday afternoons will be initially matched. In one embodiment, all other factors being equal, clients who have been subscribed to the wait list longest are ranked highest. In one embodiment, if necessary, prior to generating and sending appointment opening notification messages, multiple further iterations of the algorithm may consider additional geographical, temporal, and situational factors that have been provided to the system. In one embodiment, if the provider has indicated to the system that an appointment for a particular client is urgent, said client may receive a higher rank. In one embodiment, when an appointment opening expiry time (the time after which filling the opening is no longer possible) is impending, geographical factors such as the proximity of the client to the provider in real time are weighted strongly. Ultimately, it is an object of the invention that the client or clients who is (or are) most likely to be able to attend the open appointment are identified. In embodiments of the invention, only such clients are matched and sent appointment opening notifications. Therefore, clients that are most likely to be able to attend the open appointment are ranked highest and thus messaged in priority to other clients. If all members of the matched list have been messaged, and the appointment opening remains available, and other (yet unmatched) clients remain on the cancellation list, the algorithm may perform further iterations with broader criteria in order to generate additional potential matches. For example, if an open appointment begins at 1:30 pm, but there are no matches generated or the initial matched list is exhausted, the algorithm may message a client whose stated availability begins at 2:00 pm, who was excluded from the preceding iterations. The algorithm continues to function until the opening is filled, messages have been sent to all clients subscribed to the wait list, the expiry time elapses, or the provider elects to abort the process.

In one embodiment, appointment opening notification messages sent from the system to the matched, and possibly ranked, clients inform them of the available appointment opening, and provide the contact information of the provider so that the client may call and request the appointment, or provide a method or means by which the client can directly transmit an appointment acceptance notification to the system, thereby filling the open appointment.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1A shows a general schematic of one alternative embodiment of the system configured for the provider and the system administrator at a common location. FIG. 1B shows a general schematic of an alternative embodiment of the system configured for the provider and the system administrator being remotely located from each other. FIG. 1C schematically illustrates one embodiment of the system of the present invention.

FIG. 2a schematically illustrates the process performed by the client login module of one embodiment of the system of the present invention.

FIG. 2b schematically illustrates the process performed by the provider login module of one embodiment of the system of the present invention.

FIG. 3a schematically illustrates the process performed by the client registration module of one embodiment of the system of the present invention.

FIG. 3b schematically illustrates the process performed by the provider registration module of one embodiment of the system of the present invention.

FIG. 4 schematically illustrates the process performed by the client profile module of one embodiment of the system of the present invention.

FIG. 5 schematically illustrates the functionality of the provider profile module of one embodiment of the system of the present invention.

FIG. 6 schematically illustrates the process performed by the appointment and availability matching module of one embodiment of the system of the present invention.

FIG. 7 schematically illustrates the functionality of the messaging module of one embodiment of the system of the present invention.

### DETAILED DESCRIPTION OF PREFERRED EMBODIMENTS

The invention relates to a method and system for scheduling appointments. When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims.

As used herein, the term “and/or” means that the stated elements or features may be singly present, or may be both present.

As used herein, the term “appointment” means an arrangement between a provider and a client for the client to attend a specified location at a specified appointment time. As used herein, an appointment is “open” at a particular time if no client is scheduled for the appointment, and can include an appointment that has become open due to an unexpected event such as a cancellation or a “no-show”.

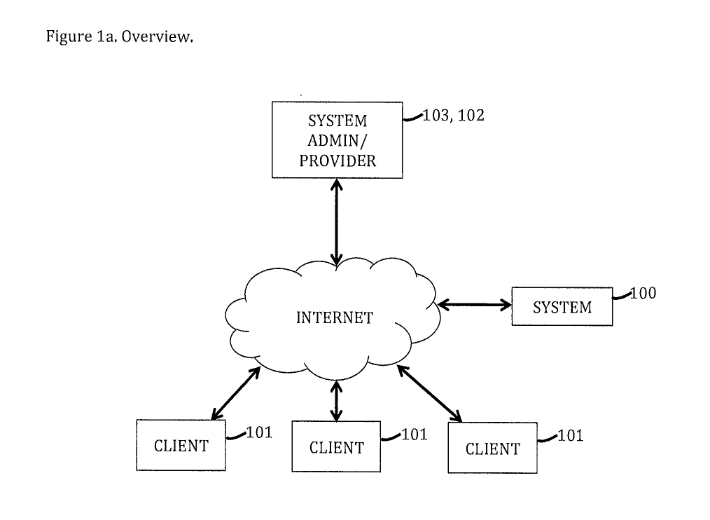

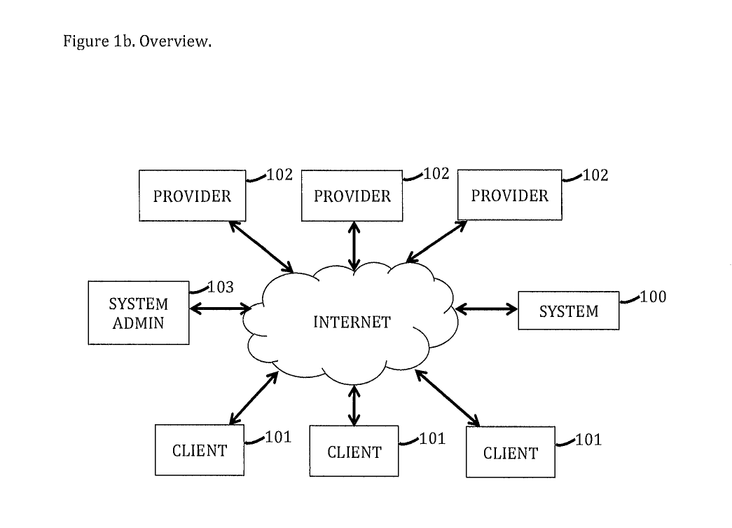

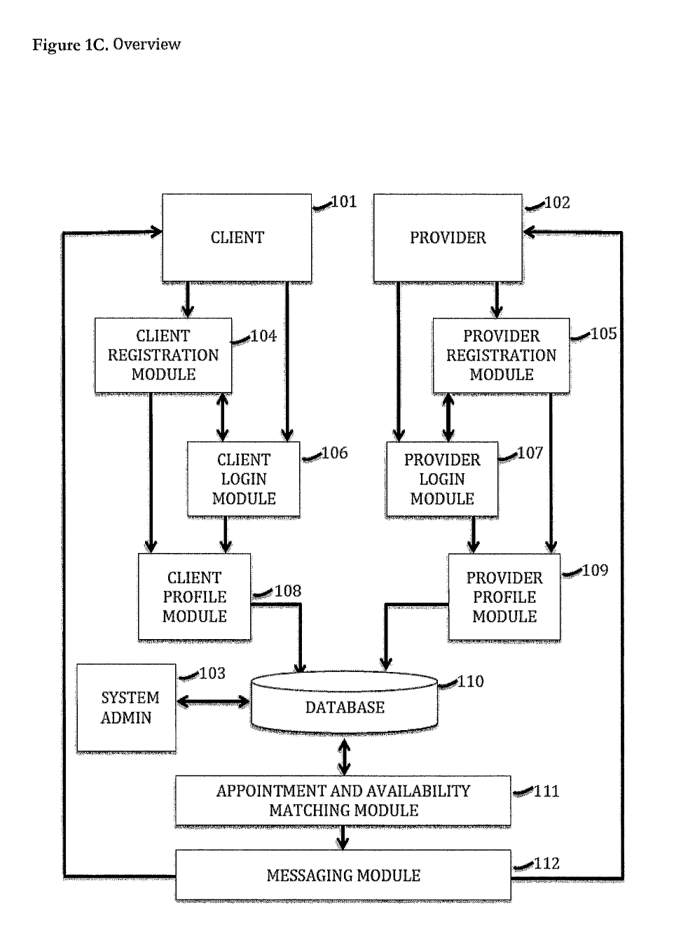

FIG. 1 schematically illustrates one embodiment of the system of the present invention. The users of this invention comprise providers (102), clients (101), and the system administrator (103). As used herein, the term “provider” means any person or entity that schedules an appointment with a client (101). As used herein, a “client” means any person with whom a provider (102) schedules an appointment. For example, a physician's administrative assistant could use this invention to simply and efficiently identify and notify appropriate patients, in a prioritized manner, of open appointments with the physician (provider (102)). As another example, a restaurant manager could use this invention to notify interested patrons (clients (101)) of sudden appointment openings at a highly desirable restaurant (provider (102)) with a long waiting list for dinner reservations. Other non-limiting examples of providers (102) who may use the present invention include recreational facilities such as sports venues or golf courses, hotels, and airlines. The system administrator (103) may be any entity that provides the appointment scheduling service, which may be the provider (102) itself, as shown in FIG. 1A. Alternatively, the system administrator (103) may be a third-party provider that maintains the system online for access by clients (101) and various providers (102), as shown in FIG. 1B.

The system alerts one or several clients (101) to the presence of an open appointment with a provider (102), with a view to filling the open appointment with that client or one of those clients (101) that is likely to be available to attend the appointment. In one embodiment, the client selected is either the most likely to be available to attend, or is most urgently in need of attending the appointment.

The system comprises a computer device which includes a memory storing a set of instructions and a processor responsive to the set of instructions to carry out the functions of the modules shown in FIG. 1. Further, it will be understood that, in some embodiments, each of the clients (101) may use client devices and the provider (102) uses a provider device(s), respectively to interact with the system. The client devices and provider device(s) may also be computer devices, and without limitation, may be smart phones, tablet computers, desktop computers, or laptop computers. A particular client (101) may use one or more client devices to access the system. For example, a single client (101) may use a laptop computer to access the system at one time, and a smart phone to access the system at another time. It will be further understood that multiple clients (101) may use a single client device to access the system. For example, several clients (101) living in a common household may use the same computer in the household to access the system. A particular provider (102) may also have access to and use one of several different provider devices.

The computer device of the system is either the same as the provider device, or is in communication with the provider device. The system may be physically integrated with the provider device. Alternatively, the system may be remotely located from the provider device, and communicate with the provider device via a communications network which may comprise an intranet, an Internet, a public switched telephone network (including wired, cellular and/or satellite transmission components) or a combination of such networks. The system is also in communication with the client devices over a communications network. The communications networks may comprise the Internet, a public switched telephone network (including wired, cellular and/or satellite transmission components), or a combination of such networks. In one embodiment, users of the system may access various modules of the system by browsing to an Internet website using standard or custom browser software.

Referring to FIG. 1C, clients (101) access the client profile module (108) after using the client registration module (104) for the first use or the client login module (106) for subsequent uses. In the client profile module (108), clients (101) link themselves to one or several providers (102) and input their specified availability to attend any appointment openings for each linked provider (102). This data is stored in the database (110), which is hosted on a computer server or servers connected to the Internet, or may be hosted by the provider (102) itself. A group of clients (101) linked to a provider (102) comprise a virtual wait list for that provider (102).

Referring to FIG. 1C, providers (102) access the provider profile module (109) after using the provider registration module (105) for the first use, or the provider login module (107) for subsequent uses. In the provider profile module (109), when an appointment becomes available (e.g., the provider (102) wishes to make new appointment times available, or there is a cancellation or “no-show” for a previously scheduled appointment), the provider (102) inputs the specifics of the available appointment opening as an appointment availability notification. The appointment availability notification includes at least the appointment time, and in embodiments, may include additional information such as the appointment location and contact information for the provider (102). In another embodiment, an appointment availability notification may be generated by the system if, for example, the client transmits a cancellation notification to the system using the client profile module (108). This information for the appointment opening notification is stored in the database (110). The appointment and availability matching module (111) then uses a dynamic algorithm (described below) to determine which clients (101) on the provider's (102) wait list should be notified, to generate a matched and ranked list of clients. The messaging module (112) then generates and sends sending an appointment opening notification message to the selected clients (101) via their preferred contact method, or several contact methods (sequentially or simultaneously). The selected clients (101) receive the appointment opening notification message and may then directly contact the provider (102) to request the appointment. In one embodiment, a method of accepting the available appointment is presented to the client (101) via the client device, as further described below. Once the appointment opening is filled, the messaging module (112) generates and sends appointment closing notification messages to those clients (101) on the matched list who received an appointment opening notification message but did not fill the opening, to inform them that the opening is no longer available. Records of messages generated and distributed by the messaging module (112) are stored in the database (110).

The system administrator (103) oversees the function and maintenance of the database (110).

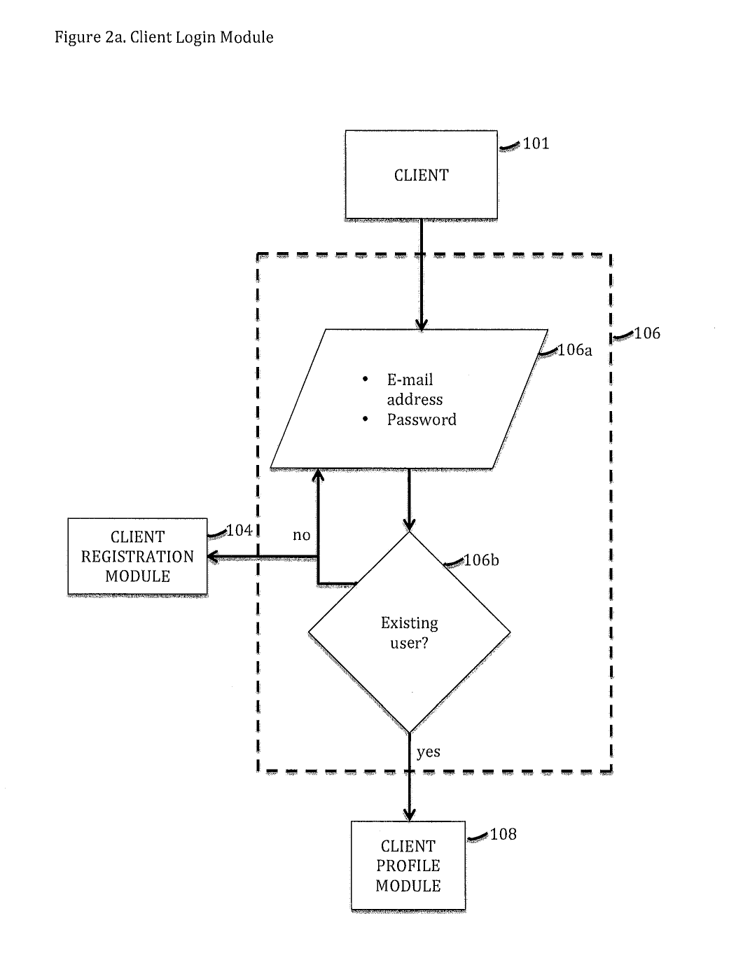

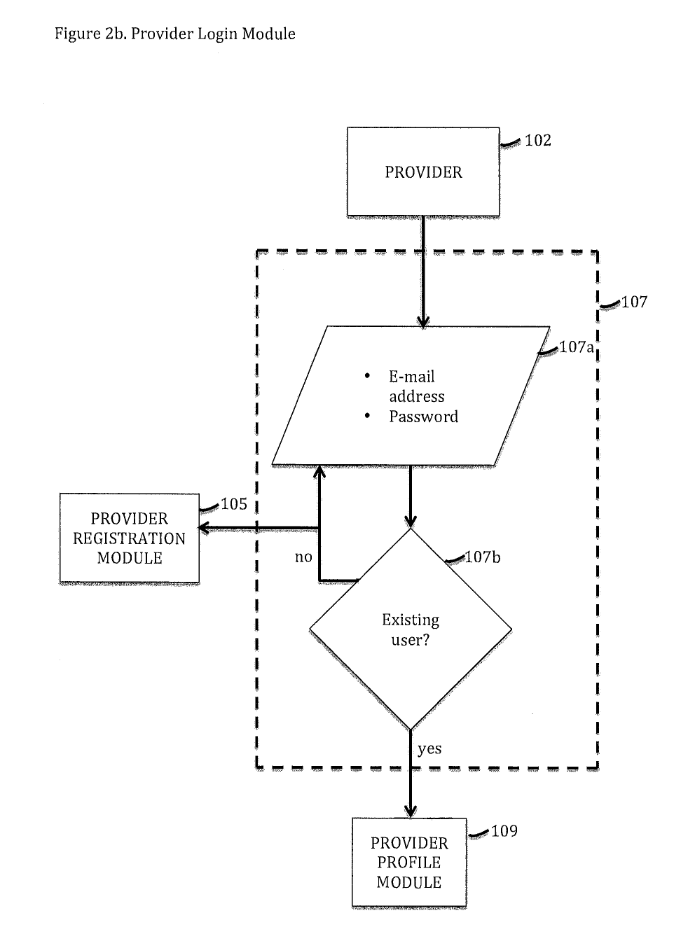

FIG. 2a schematically illustrates the process performed by the client login module (106) of one embodiment of the system of the present invention. An existing client (101) must correctly enter their unique account identifier (e.g., e-mail address or user id) and password (step 106a) generated upon their initial registration via the client registration module (104) in order to access the client profile module (108). The system checks if an account identifier stored in the database (110) matches the account identifier entered by the user (step 106b). If there is no database (110) record of an existing client (101) that matches the unique account identifier entered, then the user is given the choice to re-enter his credentials, or proceed to the client registration module (104) to register as a new client (101). If the unique identifier has been previously registered, but the entered password does not match the unique account identifier, then the client (101) is offered help to remember his forgotten password or reset his password.

FIG. 2b schematically illustrates the process performed by the provider login module (107) of one embodiment of the system of the present invention. A previously registered provider (102), after authentication (e.g., provision of e-mail address or user id, and password) (step 107a), may access the provider profile module (109). The system checks if an account identifier stored in the database (110) matches the account identifier entered by the user (step 107b). If there is no database (110) record of an existing provider (102) that matches the unique account identifier entered, then the user is given the choice to re-enter his credentials, or proceed to the provider registration module (105) to register as a new provider (102). If the unique identifier has been previously registered, but the entered password does not match the unique account identifier (step 107b), then the provider (102) is offered help to remember his forgotten password.

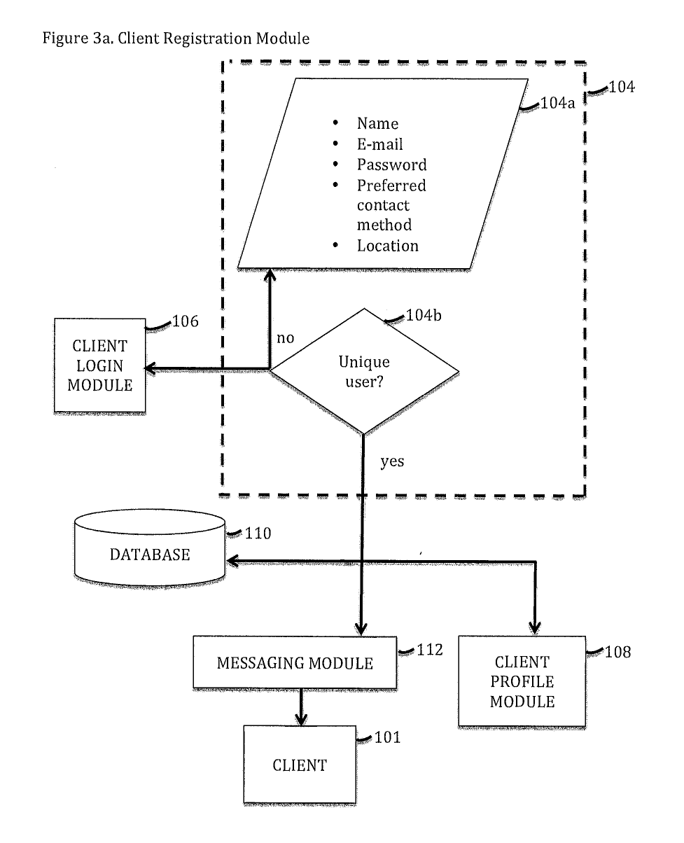

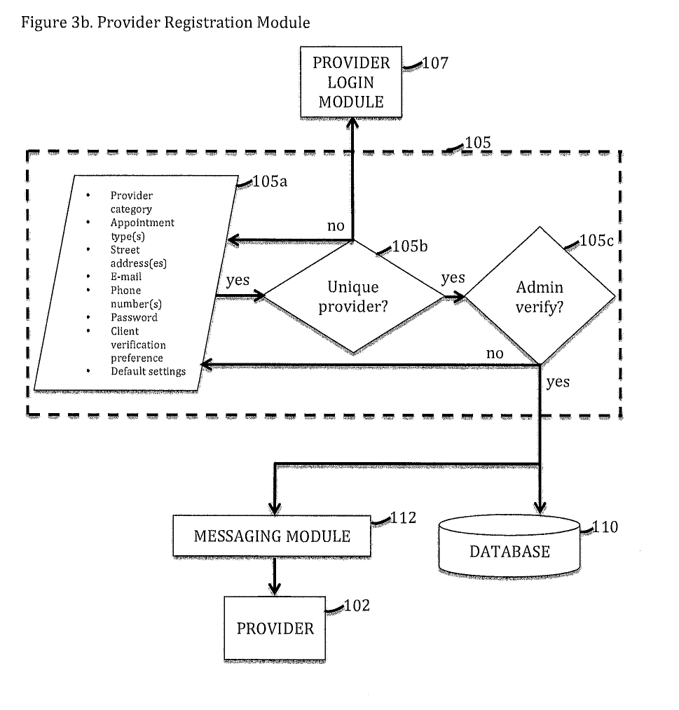

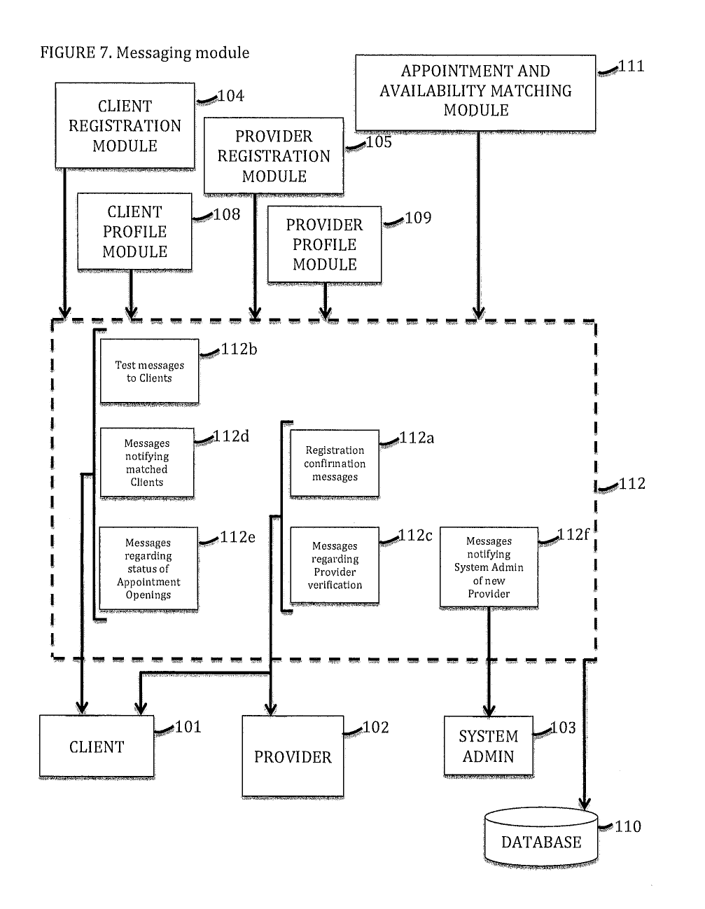

FIG. 3a schematically illustrates the process performed by the client registration module (104) of one embodiment of the system of the present invention. Upon first use of the system, the client (101) must create a client account with a unique account identifier (e.g., an e-mail address or user id), and assign a password (step 104a). Additional registration parameters include name and street address(es), as well as the preferred contact method, be it a computer-generated telephone call, SMS message, e-mail, or a social media website notification or combinations thereof (step 104a). Alternatively, a client account may be created or linked using a pre-existing social media account, such as Twitter™ or Facebook™, as is well known in the art. This information is compared to the database (110) to ensure that the client account does not already exist (step 104b). If the client's (101) entered unique account identifier is already associated with an existing client account, then the client (101) is given the choice to either input new information or proceed to the client login module (106). If the information is unique, then the registration information is stored in the database (110). A test message via the client's (101) preferred contact method is generated by the messaging module (112) to ensure functionality (as shown by function 112b in FIG. 7). The messaging module (112) sends a message to the client (101) to inform them of their successful registration. The client (101) is then directed to the client profile module (108).

In subsequent uses of the system, the client registration module (104) may not be required, but rather the client (101) can access the client profile module (108) via the client login module (106).

In examples where the provider (102) is a separate entity from the system administrator (103), FIG. 3b schematically illustrates the process performed by the provider registration module (105) of one embodiment of the system of the present invention. A new provider (102) creates a provider account with a unique account identifier (e.g. e-mail address or user id) and password. The unique account identifier is compared to the database (110) to ensure that the provider account does not already exist (steps 105b and 105c). If the provider's entered e-mail address or user id is already associated with an existing provider account, then the provider (102) is given the choice to either input new information, or proceed to the provider login module (107).

During the registration process, the provider (102) shall input several pieces of information (step 105a). First, they are asked to input their provider category, which may be, for example, physician, restaurant, or any other business or service agency that utilizes an appointment scheduler and maintains a cancellation waiting list containing information about individuals awaiting appointments. Second, the provider (102) can choose to identify and register different appointment types, such that one provider (102) who provides multiple services to clients (101) can generate separate sub-cancellation waiting lists for the different services that they provide. For example, a physician might provide services in two separate locations and thus an appointment opening at one location would not be applicable to all patients, or a restaurant provider (102) may have more than one location. Third, the provider (102) is asked to enter the street address(es) and phone number(s) for the appointment location(s). This information may be used later by the appointment and availability matching module (111) to compare location data between provider (102) and client (101). As such, one provider (102) may register several appointment types and several associated street addresses and phone numbers. This information is useful because it allows the provider's address and telephone number for the specific appointment type to be relayed to the matched clients (101) via the appointment opening notification message (as shown by function 112c in FIG. 7).

As an additional option during registration, providers (102) may specify that they wish to receive a message from the system whenever a client (101) selects said provider (102), or specify that provider (102) verification of clients (101) who select them is mandatory. For example, this option would be chosen by a medical specialist provider (102) where the specialist physician needs to verify that patients who register to their wait list have actually been referred to them. In contrast, a restaurant provider (102) that probably does not require verification of interested patrons, would not select the option. The provider (102) can also enter default values for message sending parameters, and defaults for appointment duration, type, and expiry limit.

Once all information is submitted, in one embodiment, a message to the provider (102) is generated via the messaging module (112) informing the provider (102) that verification by the system administrator (103) is pending. Upon verification (step 105c), the information is stored in the database (110) and a message is sent to the provider (102) via the messaging module (112), confirming their registration.

In subsequent uses of the system, the provider registration module (105) may not be required, and the provider (102) may thereafter access the provider profile module (109) via the provider login module (107).

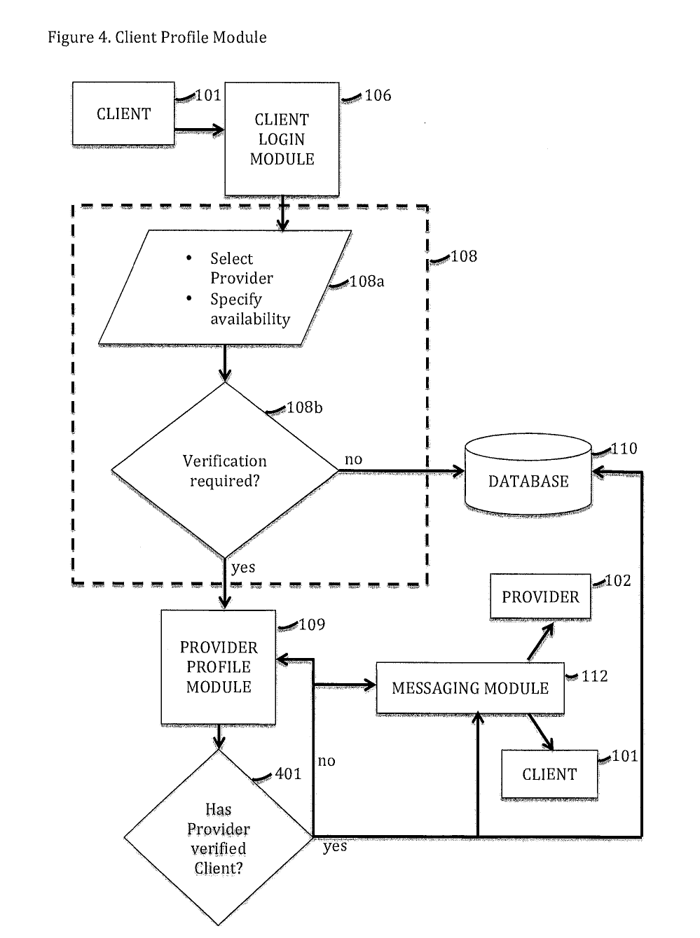

FIG. 4 schematically illustrates the process performed by the client profile module (108) of one embodiment of the system of the present invention. The client (101), following successful login authentication with their unique account identifier (e.g., e-mail address or user id) and password (106a), may register for the wait list(s) of one or any number of registered providers (102), and specify their temporal and geographical availability for an appointment opening with said provider (108a), and/or view currently available appointment openings for their providers (102). By using the client profile module (108), the client (101) may at any time update their temporal and geographical availability for an appointment opening to provide the most accurate availability information to the system in real-time. Any such parameters which reflect the client's availability or suitability for an appointment are referred to as client profile values, and collectively define a client profile set. This updating process may take place through the client (101) inputting updated information into the client device. Alternatively, the updating process may take place automatically by the client device acquiring and transmitting information to the system, with limited input by the client (101) or without any input by the client (101). In one embodiment, this updating process may be configured to take place automatically in response to the system receiving an appointment availability notification. For example, after the system receives an appointment availability notification, the system may trigger a GPS-enabled client device to automatically acquire and transmit the client's GPS location data to the system. In this manner, the system can perform the subsequent matching and ranking of clients (101) for the appointment, based on information that is as accurate as possible at the relevant time for the appointment opening.

When a provider (102) has selected a verification requirement in their provider registration module (step 105a in FIG. 3b), the client's (101) request for addition to the provider's wait list is forwarded to the provider profile module (109) which handles verification of the client's (101) request prior to adding the client's (101) request to the database (110) for later use by the appointment and availability matching module (111). During this verification process, appropriate messages are generated and delivered to the provider (102) and/or client (101) by the messaging module (112) to prompt assessment of the verification request (step 401) by the provider (102), and to update the client (101) regarding the status of the verification request (as shown by function 112c in FIG. 7). When no verification is required by the selected provider (102), the client's (101) provider (102) selection and associated availability specification parameters are immediately added to the database (110) for later use by the appointment and availability matching module (111).

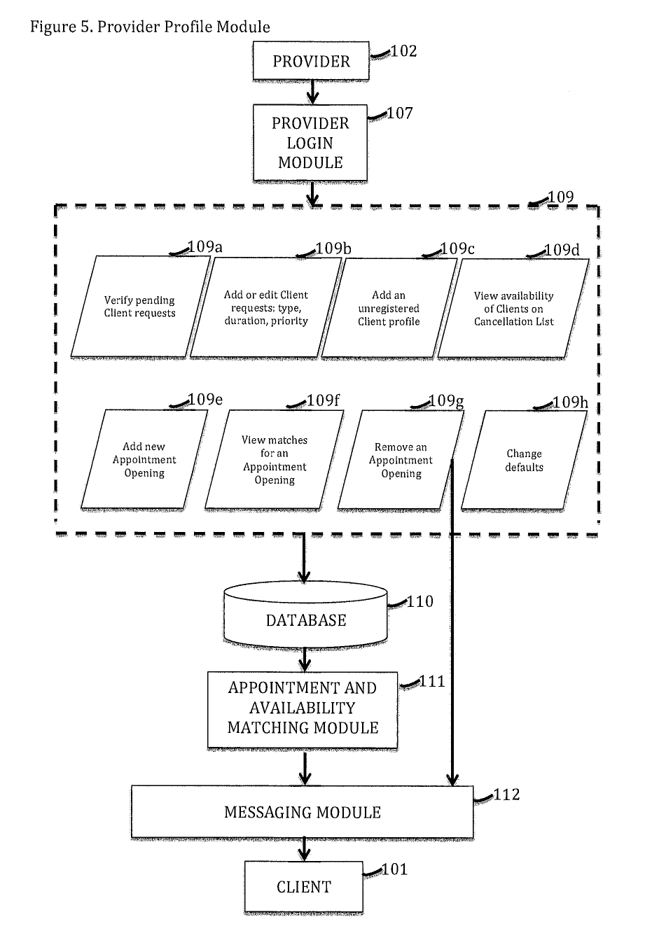

FIG. 5 schematically illustrates the functionality of the provider profile module (109) of one embodiment of the system of the present invention, wherein several actions are possible. The provider (102) can verify pending client requests (109a), define additional parameters for each client request (109b), add an unregistered client profile (109c), view the specified availability of individual clients (101) on their wait list (109d), add a new appointment opening (109e), view matches for entered appointment openings (109f), remove an appointment opening (109g), and/or change default parameters (109h). If the provider (102) has selected in the provider registration module (step 105a in FIG. 3b) that the provider (102) requires client verification, then herein the provider (102) may verify their pending client requests (109a) to authorize addition to their wait list. This information is then stored in the database (110), and the client (101) receives a message via the messaging module (112) informing them that they have been verified by the provider (102).

The provider (102) may need to define additional parameters for each client request (109b) such as appointment type, and required appointment duration. The provider (102) may also want to assign the client (101) an increased (or reduced) priority (for example, a medical specialist might want to designate a particular patient referral as urgent or non-urgent). These provider-assigned factors are added to the record of the client profile set in the database (110) for future use by the appointment and availability matching module (111), but are not visible to or modifiable by the client (101).

Occasionally, clients (101) will emerge who are not comfortable registering themselves, for example because of lack of access to or lack of experience with client device technology. In these instances, a provider (102) may add an unregistered client profile (109c) on the client's (101) behalf and populate the client's (101) client profile set. This information is stored in the database (110).

Herein the provider (102) may also view the specified availability of individual clients (101) on their wait list (109d), as well as view the matched and ranked list (109f) generated by the appointment and availability matching module (111) for each active appointment opening. The provider (102) will be able to see which matched clients (101) have already been notified about each opening, and which clients (101) have notifications pending. The provider (102) will have the flexibility to immediately message one or more matched clients (101) regardless of the client's (101) position in the ranked list.

When a provider (102) adds a new appointment opening (109e), the provider (102) specifies the date and time. At the same time, the appointment type and/or location, duration, and expiry limit of the appointment opening may be modified from the defaults. The provider (102) may also customize the message sending parameters (e.g., the number of simultaneous messages to send and how often to send them). This information is then added to the database (110), and the appointment and availability matching module (111) immediately begins using this information to generate a matched and ranked list of clients (101) who will receive appointment opening notification messages via the messaging module (112) (described later).

When an appointment opening is filled or the provider (102) decides they no longer wish to broadcast a previously entered appointment opening, the provider (102) can remove the appointment opening (109g). The provider (102) is prompted to identify which client (101) filled the opening, if any, and, via messages from the messaging module (112), any and all clients (101) who did not fill the appointment but who were initially informed of it are advised that the appointment is no longer available. The appointment is marked as no longer open in the database (110).

Providers (102) also have the option to adjust their default settings which were initially entered in the provider registration module (109h).

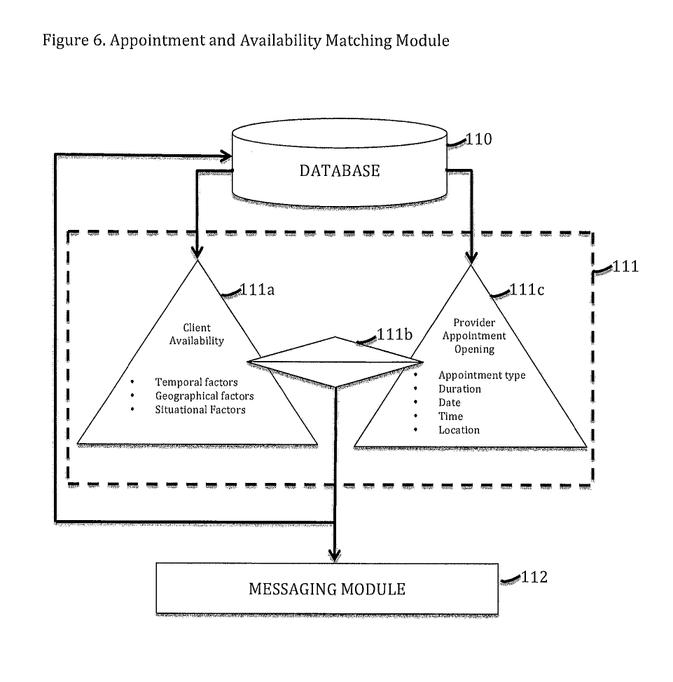

FIG. 6 schematically illustrates the process performed by the appointment and availability matching module (111) of one embodiment of the system of the present invention. The availability matching module (111) receives the parameters of an appointment opening (111c) as entered into the database (110) by the provider (102) through the provider profile module (109a), and compares such parameters with the client availability parameters (108a) for clients (101) subscribed to said provider's (102) wait list for the purpose of generating appointment opening notification messages to matched clients (101), via the messaging module (112). The appointment and availability matching module (111) employs a dynamic algorithm utilizing the provider-entered parameters of an appointment opening (date, time, duration, type, and expiry limit), and compares these to the client-entered temporal availability parameters, as well as the client's (101) required appointment type, required appointment duration, and a priority as specified by the provider (102), if applicable.

Using this information, the appointment and availability matching module (111) algorithm generates a sequential or prioritized list of appropriate clients (101) to receive notification messages about the available appointment opening. In one embodiment, an initial ranking is determined by the length of time each matched client (101) has been subscribed to the provider's wait list (i.e., assigning the first appointment opening notification to the client (101) who has been on the wait list for the longest time as determined by the time when the client (101) subscribed to the provider (102), and the client's (101) last appointment, if any). If necessary, the ranking of said wait list may then be further modified by additional parameters including the clients' physical location as determined by street address and/or stated proximity to the provider (102) and/or stated advance notice required and/or real-time client location obtained via location data from client's mobile cellular device, GPS device, or Internet-connected device. For example, when the current time is very close to the expiry time of the appointment opening in question, a client (101) with very limited temporal availability who is geographically close to the provider location, and/or who has indicated that they require the least amount of advance notice in order to attend said appointment opening will receive a higher ranking and thus priority notification about the appointment opening as compared to a client (101) with wide temporal availability (i.e., the cumulative amount of time that the client (101) is available), who is farther away from the provider location and/or requires longer advance notice, even if the latter has been subscribed to the wait list for a longer time. In other embodiments, the appointment and availability matching module (111) may assign other priorities or weighting factors to one or more of the client availability parameters and the provider appointment opening parameters, which can be customized by the provider (102) to suit the provider's preferences.

After generating a ranked list of matching clients (101), the appointment and availability matching module (111) sends notifications to the matched clients (101) in ranked order through the messaging module (112). The provider (102) is able to specify how matching clients (101) are notified, for example either one at a time, or in batches, and at specified time intervals, through preference defaults set at the time of registration in the provider registration module (105a) or as a one-time deviation from the defaults at the moment of adding the new appointment opening (109a). The provider (102) may also choose not to send the computer-generated messages via the messaging module (112), and simply access the ranked list of matched clients (101) to use at their own discretion, through the provider profile module (109). The appointment and availability matching module (111) sends information to the database (110) regarding all messages delivered, for statistical tracking purposes.

The appointment and availability matching module (111) stops generating matches and initiating notification messages when the appointment opening is filled, the expiry limit of the appointment opening has passed, the ranked matched list of clients (101) is exhausted, or the provider (102) terminates the process. The expiry limit of the appointment opening may be a preset time which contemplates the latest arrival of the client (101) which is still acceptable to the provider (102). The expiry limit may therefore be a preset amount of time before or after the start time of the contemplated appointment. As an example, for a physician working in a multi-physician clinic, the expiry limit for a medical appointment may be set to a minimum amount of advance notice that the physician prefers to have prior to the scheduled start of the appointment. In this manner, if the appointment is not filled before the expiry limit, then the physician will be able to plan in advance to use the appointment time for other tasks. Further, the resources that would have been required by the appointment can be allocated to other physicians, and possibly trigger appointment availability notifications for those other physicians who are also using the system.

The appointment and availability matching module's (111) purpose is to efficiently identify and notify which client(s) (101) subscribed to the provider's wait list are most likely to be able to attend any given appointment opening submitted by the provider (102). The dynamic matching and ranking algorithm is designed to rapidly identify and only send appointment opening notification messages to selected clients (101) who are actually available to attend the appointment opening in question, and furthermore is designed to send messages preferentially to those clients (101) who the system determines should be the most likely to be able to attend said appointment opening based on as many known temporal, geographical, and situational factors as possible, and/or those clients (101) whom the provider (102) considers high priority.

FIG. 7 schematically illustrates the functionality of the messaging module (112) of one embodiment of the system of the present invention. Several other modules (104, 105, 108, 109, 111) communicate with the messaging module (112), which generates and delivers a variety of messages to providers (102) via computer-generated e-mail, SMS messaging, social media website notification, or telephone call, and to clients (101) via the clients' preferred contact method(s), as defined in the client registration module (104).

The provider or client registration modules (104 and 105, respectively) communicate via the messaging module (112) to inform the client (101) or provider (102) that their registration is pending verification or has been successful (112a).

Upon initial client registration, or if said client (101) later changes their preferred contact method, a test message (112b) is sent to the client (101) via the clients' preferred contact method to ensure functionality.

When a client (101), via the client profile module (108), selects addition to a provider's wait list, if said provider (102) has indicated in the provider registration module (105) that they require client verification (105a), then a message is sent to the provider (102) informing them that said client's verification request is pending (112c). When, via the provider profile module (109), the provider (102) either verifies or declines the pending client verification request (109a in FIG. 5), a message is sent to the client (101) informing them of the outcome (verified or declined) (112c).

When the appointment and availability matching module (111) generates a matched and ranked list of clients (101) to be sent appointment opening notification messages regarding an appointment opening, a message is sent to each client (101), either simultaneously or in timed succession (either individually or in groups), as per the provider preference. In one embodiment, the notification messages to the client(s) (101) identify at least the provider (102) and appointment opening date and time. Preferably, the notification further includes location, and provider contact information (112d), as well as instructions for the client (101) to contact the provider (102) should they wish to claim the available appointment opening. In one embodiment, the notification presents a method of accepting the available appointment to the client (101) via the client device. As a non-limiting example, an appointment availability notification message sent as an e-mail may contain a hyperlink, which when selected causes the client device to transmit an appointment acceptance notification to the system. As another non-limiting example, an appointment availability notification message sent as a telephone call, may contain a voice-message prompt for the client (101) to press a specified key on a touch-tone keypad of the telephone client device to transmit an appointment acceptance notification.

When an appointment is made no longer available by any appointment closing mechanism, follow-up messages may be sent to any and all clients (101) who already received appointment opening notification messages but were not successful in filling the appointment opening, such that they no longer attempt to claim the appointment opening.

Upon provider registration, a message is sent to the provider (102) informing them that verification by the system administrator (103) is pending (112f). Upon verification (105c), the information is stored in the database (110) and a message is sent to the provider (102) via the messaging module (112), confirming their registration (112a).

For analytical and statistical purposes, the database (110) logs all sent messages for later review by the system administrator.

As will be apparent to those skilled in the art, various modifications, adaptations and variations of the foregoing specific disclosure can be made without departing from the scope of the invention claimed herein.

### REFERENCES

The following references are incorporated herein by reference (where permitted) as if reproduced in their entirety. All references are indicative of the skill of those skilled in the art to which this patent pertains.
Parikh et al. The Effectiveness of Outpatient Appointment Reminder Systems in Reducing No-Show Rates. The American Journal of Medicine. 2010; Vol 123, No 6; 542-548. [Parikh et al., 2010].
Lehmann et al. Missed Appointments at a Swiss university outpatient clinic, Public Health. 2007; 121: 790-799. [Lehmann et al., 2007].

1. A method for scheduling an appointment at an appointment time between a provider and one of a plurality of clients, the method implemented by a computer comprising a processor and a memory, the computer either comprising a provider device or in communication via a network with a provider device used by the provider, and in communication via a network with at least one client device used by at least one of the plurality clients, wherein each client is associated with at least one client profile value indicative of the client's availability for the appointment, the method comprising the steps of:
(a) in response to receiving an appointment availability notification from the provider device, selecting at least one client that is or are likely available for the appointment by comparing the at least one client profile value associated with each client to at least one evaluation parameter; and
(b) triggering a transmission of an appointment opening notification selectively to the client device used by the at least one selected client, wherein the appointment opening notification comprises the appointment time.

2. A method for scheduling an appointment at an appointment time between a provider and one of a plurality of clients, the method implemented by a computer comprising a processor and a memory, the computer either comprising a provider device or in communication via a network with a provider device used by the provider, and in communication via a network with at least one client device used by at least one of the plurality of clients, wherein each client is associated with at least one client profile value indicative of the client's availability for the appointment, the method comprising the steps of:
(a) providing a website for communicating with the provider device and the plurality of client devices;
(b) receiving from the provider device, via the website, an appointment availability notification;
(c) receiving from either the provider device or the at least one client device, or a combination thereof, via the website, the at least one client profile value for each client;
(d) selecting at least one client that is or are available for the appointment by comparing the at least one client profile value associated with each client to at least one evaluation parameter; and
(e) triggering a transmission of an appointment opening notification selectively to a client device used by the at least one selected client, wherein the appointment opening notification comprises the appointment time.

3. The method of claim 2 wherein the appointment opening notification further comprises one or more of a provider location, a provider contact information, or a means for accepting the appointment opening.

4. The method of claim 2 wherein the at least one client profile value is one or more of: a client availability period; a cumulative time amount of client availability periods; a client waiting time; a client location; a client urgency; a client advance notice period; or a client demographic factor.

5. The method of claim 4 wherein the at least one client profile is the client waiting time, and the at least one evaluation criterion is the client waiting time of other clients.

6. The method of claim 2 further comprising the step of receiving from the provider device via the website, at least one appointment profile value indicative of an appointment parameter, and wherein the at least one evaluation criterion comprises the at least one appointment profile value.

7. The method of claim 6 wherein the at least one appointment profile value comprises one or more of: the appointment time; an appointment location; appointment duration; or an appointment type.

8. The method of claim 6 wherein the at least one client profile value comprises the client availability period and the at least one appointment profile value comprises the appointment time.

9. The method of claim 6 wherein the at least one client profile value comprises a client location and the at least one appointment profile value comprises an appointment location.

10. The method of claim 9 wherein the client location is based on location information acquired from the client device.

11. The method of claim 2 wherein the step of receiving the at least one client profile value comprises monitoring for transmission of the at least one client profile value from the plurality of client devices, after the receiving the appointment availability notification.

12. The method of claim 2 wherein the comparing step comprises assigning a weighting factor to each of a plurality of client profile values associated with each client.

13. The method of claim 12 wherein the weighting factors are variable dependent on the temporal proximity to an appointment expiry limit.

14. The method of claim 2 further comprising the step of ranking a plurality of selected clients, and the triggering step with respect to any one selected client is contingent on that selected client's rank relative to the rank of other selected clients.

15. The method of claim 2 further comprising the step of ranking a plurality of selected clients, and the triggering step is performed sequentially for the selected clients, with the sequence determined by the relative ranks of the selected clients.

16. The method of claim 2 wherein the selecting step is performed iteratively by comparing either a different or modified profile value or a different or modified evaluation criterion in each iteration, until at least one client is selected.

17. The method of claim 2 wherein the appointment opening notification is transmitted via one or more of the following message services: a SMS message; an e-mail; an electronic message, a social media notification, or a telephone call.

18. The method of claim 2 wherein the appointment opening notification is transmitted by a telephone call and comprises a prompt for a voice or tone command for the client to transmit an appointment acceptance notification via an interactive voice message system.

19. The method of claim 2 wherein the appointment opening notification is transmitted by an SMS, an e-mail, an electronic message, or a social media notification, and comprises a link or hyperlink that may be selected by the client to transmit an appointment acceptance notification.

20. The method of claim 14 further comprising the step of: in response to receiving an appointment acceptance notification from a client device, triggering a transmission of an appointment closing notification to the client device of any selected client that did not transmit an appointment acceptance notification.

21. A system for scheduling an appointment at an appointment time between a provider and one of a plurality of clients, the system comprising a processor and an operatively connected memory storing a set of instructions, wherein the processor is part of a provider device, or is capable of communicating with a provider device, and capable of communicating via a network with at least one client device used by at least one of the plurality of clients, wherein the processor is responsive to the set of instructions to implement a method as described in claim 1.
